(19) United States
(12) Patent Application Publication
(10) Pub. No.: US 2025/0286507 A1
(43) Pub. Date: Sep. 11, 2025

(54) Virtual Synchronous Condenser

(71) Applicant: Maxout Renewable, Inc., Livermore, CA (US)

(72) Inventors: Eric B. Cummings, Livermore, CA (US); Kirsten Pace, Livermore, CA (US)

(73) Assignee: Maxout Renewable, Inc., Livermore, CA (US)

(21) Appl. No.: 19/075,337

(22) Filed: Mar. 10, 2025

Related U.S. Application Data
(60) Provisional application No. 63/563,313, filed on Mar. 9, 2024.

(51) Int. Cl. H02S 40/32; H02J 3/00; H02J 3/38; H02S 40/38

(52) U.S. Cl. CPC H02S 40/32; H02J 3/00125; H02J 3/381; H02S 40/38; H02J 2300/24

(57) ABSTRACT

Prior art photovoltaic (PV) and energy storage systems (ESS) are of little help during a power outage because most PV inverters do not have islanding capability or are unable to provide substantial surge power, requiring overprovisioning of ESS to power high-surge loads, such as an air conditioner. This problem can be solved by drawing inspiration from the Synchronous Condenser, a surge-power source and sink used to stabilize power grid circuits via a flywheel connected to a synchronous motor/generator. A system can comprise a virtual synchronous condenser (VSC) that can source and sink higher power than conventional ESS at a fraction of the price. The VSC herein disclosed is also modular and supports ESS and management of external non-islanding photovoltaic inverters and external photovoltaic DC power sources and handles surge power in systems with ESS so they can be sized for average instead of peak power usage.

### CROSS-REFERENCES TO RELATED APPLICATIONS

This application claims the benefit of U.S. Provisional Application No. 63/563,313, filed on Mar. 9, 2024, which is incorporated by reference for all purposes.

### BRIEF DESCRIPTION OF THE DRAWINGS

FIG. 1A is a schematic diagram of an embodiment of a virtual synchronous condenser (VSC) comprising a breakable connection to an external battery.

FIG. 1B is schematic diagram of an embodiment of a VSC comprising an internal surge power source/sink.

FIG. 1C is a schematic diagram of an embodiment of a VSC further comprising a bulk battery storage stage.

FIG. 1D is a schematic diagram of an embodiment of a VSC comprising an interface to the DC output of a PV array.

FIG. 2A is an electrical schematic diagram of an embodiment of an agile dump circuit for managing power surges or excess power on an AC line.

FIG. 2B is an electrical schematic diagram of an embodiment of an agile dump circuit for managing power surges of excess power on a DC line.

FIG. 3 is an electrical schematic diagram of a modular interleaved inverter, bidirectional boost circuit embodiment.

FIG. 4 is an electrical schematic diagram of a modular interleaved bidirectional boost circuit embodiment.

FIG. 5 is a schematic diagram of an embodiment of a VSC system comprising surge, bulk storage, and DC PV power processing.

FIG. 6 is a drawing of an embodiment of a VSC system comprising arrayed and cascaded power modules.

FIG. 7A is a drawing of an embodiment of an individual power module.

FIG. 7B is a top view of an embodiment of an individual power module without its chassis.

FIG. 7C is a bottom view of an embodiment of an individual power module without its chassis.

FIG. 7D is a three-dimensional view of an embodiment of an individual power module without its chassis.

FIG. 7E is a three-dimensional view of an embodiment of an individual power module without its chassis, input filter assembly, and capacitor modules.

FIG. 7F is a three-dimensional view of an embodiment of an individual power module disassembled to the power switches.

FIG. 7G is a three-dimensional view of an embodiment of the ground plate assembly that supports low-side current-sensing via a resistor.

FIG. 8A is a drawing of one embodiment of an input filter module.

FIG. 8B is a drawing of another embodiment of an input filter module, further comprising an active circuit breaker.

FIG. 9 is a detailed view of an embodiment of a switch half bridge showing novel mounting method.

FIG. 10 is a drawing of an embodiment of the switches and switch printed circuit board assembly.

FIG. 11 is a drawing of an embodiment of a controller board.

### DETAILED DESCRIPTION OF THE INVENTION

A conventional synchronous condenser is a generator, synchronous motor, or induction motor coupled to a flywheel. This kind of device has been used to stabilize an AC waveform in a power grid because, when spinning synchronously with an AC waveform of having the correct combination of root mean square (RMS) voltage, herein called the “synchronous voltage” and frequency, herein called the “synchronous frequency,” and instantaneous phase, herein called the “synchronous phase” the motor reacts to brief disturbances in the AC waveform by converting kinetic energy to and from the flywheel into a countering electrical power up to the power capacity of the motor.

A synchronous condenser, thus may supply or sink substantial surge power in response to transient loads. In some synchronous condensers, an electric regulator of a rotor or stator winding may be used to change the synchronous voltage for a given synchronous frequency and further allow the active sinking or sourcing of reactive power. In some embodiments, the synchronous frequency and voltage are substantially predetermined via geometry and winding ratio.

A drawback of a synchronous condenser is that the apparatus uses power to overcome bearing friction, air resistance, coil losses, core losses, and eddy current losses from leaked magnetic fields, even while “idling,” which herein refers to operating undisturbed at the synchronous frequency and voltage. In some generators, these idle losses may be between 10 and 50% of the rated generator power. In some generator embodiments, the idle losses are more severe than non-idle losses because current in the stators may counter the magnetic field from the rotor that would otherwise leak to produce eddy currents in the case. In some embodiments of a synchronous condenser, these eddy current losses are reduced by the use of a motor housing containing at least one oriented non-conducting slot. Some embodiments comprise a case material having a high electrical resistance. Some embodiments comprise a motor housing comprising an electrical insulator having a substantial gap between the source of a rotating magnetic field to the closest conductor so that the magnitude of the magnetic field changes is reduced. Some embodiments comprise a magnet or electromagnet configuration in which the idle fields are substantially constant in the frame of reference of the motor mount. Some such embodiments comprise a permanent magnet or electromagnet-based stator and a wound rotor from which power is extracted. Some embodiments comprise circuitry that regeneratively draws current from a stator winding and feeds this energy back to a winding that partly counters the leakage field and induces a compensating rotor torque that reduces motor losses.

Some preferred embodiments comprise a “virtual synchronous condenser” (VSC) as used herein, a device that reacts to a disturbance in the synchronous frequency, phase, and voltage by sourcing and sinking power to oppose the disturbance. The effects of waveform disturbances vary based on the type of load. A voltage spike can cause breakdown of capacitors or gates in primary and secondary circuits. A rapid change in phase or frequency may interfere with motors and connected machinery, an extended departure from an ideal waveform may increase power losses in motors, an absolute frequency error may affect the operation of devices using synchronous motors. The switching on and off of loads may couple into other loads in undesirable ways, such as the flickering of lights, audio interference, and device resets, etc. A goal of a VSC, in some embodiments, may be to keep a photovoltaic (PV) inverter designed for grid-tied use producing power rather than tripping its output off.

In some embodiments, a VSC may source power to compensate for the momentary tripping of a PV inverter. In some embodiments, the VSC may comprise circuitry to isolate a PV inverter from a load. In some embodiments, the VSC may comprise circuitry to supply an AC waveform to an external PV inverter to allow the PV inverter to begin sourcing power. In some embodiments, a VSC may employ direct current (DC) PV energy, in whole or in part, to provide power for the AC waveform. In some embodiments a VSC may comprise an inverter having a plurality of power inputs.

As used herein, the term “surge” power or capacity refers to a short-term or transient timeframe, e.g., up to minutes, while “bulk” power or capacity refers to a longer-term or transient time frame, e.g., up to days or weeks.

Some embodiments of a virtual synchronous condenser comprise at least one power source and preferably a plurality of power sources, each specialized to cover a frequency, current, or power range. Some embodiments of power sources comprise one or more of a battery, a lead-acid battery, a lithium-ion battery, a LiFePO₄ battery, a solid, liquid, or gas-phase fuel cell, a brushless de motor and flywheel, a supercapacitor, a capacitor, a film capacitor, a ceramic capacitor, an electrolytic capacitor, an inductor, a PV panel, a PV array.

Some embodiments of a virtual synchronous condenser comprise at least one power sink and preferably a plurality of power sinks, each similarly specialized. Some power sinks comprise one or more of a battery, a lead-acid battery, a lithium-ion battery, a LiFePO₄ battery, a solid, liquid, or gas-phase fuel cell, a brushless DC motor and flywheel, a supercapacitor, a capacitor, a film capacitor, a ceramic capacitor, an electrolytic capacitor, a resistor, an inductor, a lossy inductor.

In some preferred embodiments, at least one power source and power sink may be the same object driven bi-directionally.

Some embodiments of a virtual synchronous condenser as known in the art are used in a system to establish and maintain a microgrid or nanogrid to power a limited set of loads, for example, a single house, business, or neighborhood, during periods of grid power outage or while otherwise disconnected from an electrical grid. As used herein, there is no distinction between ‘microgrid’ and ‘nanogrid’ that essentially bears on the architecture of the virtual synchronous condenser and the terms are used interchangeably.

An air conditioner unit may comprise a challenging load on a microgrid. A typical household air conditioner of 5-ton capacity may introduce a surge requirement of the order of ˜15 kVA for of the order of 1 s and a real peak power of order 10 kW on startup as rotors accelerate. In a typical household, the roof area may be >3 times too small to provide this power from solar panels. The rechargeable battery bank to support that power may be several times larger than is needed to time-shift daily power use, provide backup power and perform other valuable functions. Over-provisioning a conventional battery bank for the purpose of starting an air conditioner may double the entire cost of the solar installation.

An objective of some embodiments, therefore, is to provide the capacity via a virtual synchronous condenser to produce this level of surge power cost effectively.

Actively braked motors and switched inductors may also introduce a large pulsed power surge back onto an AC line. Furthermore, a power source, such as an inverter may produce more power than is being consumed instantaneously on the microgrid, especially when a powerful load is switched off. Without voltage stabilization, such a surge can induce voltage spikes that can trip a PV inverter into an alarm state, damage electronics, and produce arcing.

An objective of some embodiments, therefore, is provide the capacity via a virtual synchronous condenser to absorb this level of surge power cost effectively.

VSC Surge Sources: A typical target for the surge capacity of a residential VSC may be of order 10 kW for of order of 5 seconds, or 50 kJ of storage.

Supercapacitor: One may apply supercapacitors or ultracapacitors, as known in the art to store this energy. At ˜$10k/1 kW-hr, this capacity would cost ˜$140. An advantage of a supercapacitor solution may be that the supercapacitors can source and sink power at a high rate. The state of charge of the supercapacitor would have to be set to less than 100% in order to provide a sink capability. The voltage of the supercapacitor also changes with discharge, so in practical systems, circuitry to convert this energy may use additional current capacity or stages or extra ultracapacitor capacity. A supercapacitor source may be best used in a VSC system that is permanently off grid, since the source may see considerably more cycles than a VSC that is only used for backup power. While they have many of the same conversion system requirements, the current capacity, equivalent series resistance, and limited lifetime of electrolytic capacitors and the high cost per Joule of film capacitors may affect the economy of that alternative.

‘Starter’ battery: An automotive ‘starter-motor’ battery may be rated by its “cold-cranking amps,” a measure of worst-case surge power production at low temperature, intended to ensure that the battery can supply ample power in freezing weather to start an engine. A typical inexpensive automotive battery may be specified for 600 A at 7.2 V output, driven down from ˜12 V by internal resistance and reaction rate kinetics, thus the battery is specified to produce a worst-case surge power of >4.3 kW for a several-second starting time. In this time the battery is typically depleted by less than 1% of its capacity. At room temperature, the current capacity may be several times higher because of faster chemical kinetics. Thus, an automotive battery can supply ˜5-10 kW peak surge power. The use of this surge capacity may degrade a battery over time. A lead-acid battery may provide between 103 to 105 such ‘starts’ before its internal resistance degrades excessively. An air conditioner cycling on every half hour would cycle 50 times a day, so the lifespan of such a battery may be 20-2000 days. The replacement cost of such a battery may be around $100 and such batteries may be stocked ubiquitously.

Jumpered automotive battery: If needed, a battery could be jumpered to a starter battery installed in or removed from a vehicle to support a VSC. This type of power source may be most economical for a VSC used for backup power during an outage or disaster. While lead batteries may pose environmental challenges, the raw materials are readily obtained and the batteries can in theory be highly recyclable. The use of a lead-acid battery would allow for providing a modest bulk backup power capacity in addition to the surge capacity.

Premium Batteries for bulk storage: Alternative battery technologies, such as lithium ion and LiFePO₄ are ‘premium’ batteries and may be best used for bulk-power management instead of surge power management which may prematurely reduce their lifespan. In some preferred embodiments, such a battery array may directly or via a balancing circuit feed a “bulk-storage” bus to and from which a limited surge power may pass indirectly from an AC surge, that bulk storage bus voltage sensed, and upon crossing an upper and lower threshold or by the action of an automatic control loop, a secondary surge power source activated. In some embodiments, the secondary power source feeds and drains power to the bulk storage bus. In some embodiments the secondary power source feeds and drains power from another bus in communication with the AC surge such that the surge load on the bulk-storage bus is reduced. Some embodiments of VSCs may provide bulk AC power via converters that draw on the “bulk-storage” bus.

First Source (surge): Some embodiments of VSCs comprise a first power source comprising one or more of: an ultracapacitor bank, a lead-acid battery, a ‘starter-motor’ battery, a lithium ion or LiFePO₄ battery optimized for high discharge current. This first power source being primarily activated for surge, e.g., <1-100 s, power sinking and sourcing.

Second Source (bulk): Some embodiments further comprise a second power source comprising one or more of a bulk storage battery, lithium-ion battery, LiFePO₄ deep-cycle lead-acid battery, activated glass mat battery, etc. This second battery being activated to supply or sink bulk e.g., >100 s power. In some embodiments, the first and second power sources may be the same hardware or a co-located hybrid power device.

Third Source (renewable): Some embodiments of VSCs further comprise a third power source comprising one or more of: a renewable energy source, a PV panel, a PV panel array, a wind generator, a tide generator, a hydroelectric generator, a thermoelectric generator, a Stirling generator. The third power sources being used as a source of bulk power and to recharge a first and second power source.

Bridge bus: In some embodiments, at least one power source uses voltage boost circuitry to feed the DC input of at least one inverter to produce efficiently an AC power waveform, e.g., typically >90 VAC and often up to ˜245 VAC for residences and commercial buildings. Some alternative embodiments comprise two split boosted buses to produce a positive and negative supply about a neutral center voltage.

Bi-boost stage: In some embodiments, one or more boost stage is designed as a bidirectional circuit herein called a “bi-boost” wherein current may be regulated to flow efficiently from a lower voltage node to a higher voltage node in the manner of a conventional boost and may also be regulated to flow efficiently from a higher voltage node to its lower-voltage node. A bi-boost stage may allow a lower-voltage bus to contribute power to a higher-voltage bus and vice versa for example, to perform charge balancing, to establish a state of charge or state of discharge by transferring power between power sources, and to cascade power up or down between a series of buses to handle AC surges.

First bus: Some preferred embodiments comprise first bi-boost circuitry having at least one bi-boost stage to raise a power source voltage to a first bus voltage. This first bus voltage may be common or unidirectionally fed by a third power source, such as a renewable energy source, which may be variable depending upon the maximum power point of that source. For example, a PV array may feed the First bus directly through a diode or switch during the day, but backwards flow of current may be blocked when illumination is low. Some preferred embodiments of the First bus are fed by a photovoltaic string. In some preferred embodiments, the connection to the PV string may be made through a shutoff switch, a breakable connection, terminal blocks, etc.

A plurality of such First buses may be used at different bus voltages, as known in the art to support multiple, independently power optimized renewable energy sources, e.g., strings of solar panels.

Boost inverter operation: In some embodiments, the first bus is in direct communication with at least one boost inverter module.

Buck inverter operation: Some preferred embodiments utilize a First bus voltage between ˜30 to 200% of the peak-to-peak AC waveform voltage to be produced. In some embodiments, a bi-boost converter may convert the First bus voltage to a bridge bus for at least one buck inverter module having a voltage >100% of the peak-to-peak AC waveform voltage. If the First bus voltage does not require or use boost, the bi-boost circuit may efficiently bypass the boost circuitry to produce a bridge bus for at least one buck inverter module.

Inverter interleaving: Some preferred embodiments interleave the switching of a plurality of inverter modules. This may confer one or more advantages of: reducing filter requirements, improving time response, providing for simple power scaling, distributing heat, providing redundancy.

Low Voltage boost stage: Some embodiments comprise a bi-boost stage designed to boost from a low-voltage source, for example ˜2-30V and preferably ˜5-25 V to a medium voltage bus ˜30-100 V. Such embodiments may facilitate the use of an automotive starter battery or the like, a supercapacitor array, an electrochemical cell, or a fuel cell, etc. or a series and parallel connection combination of multiple such power sources as a surge power source that feeds the medium-voltage bus. A starter battery may droop nearly 50% in voltage under full load. A supercapacitor bank may discharge voltage by 100%, but may be economically limited to ˜50% discharge. In some embodiments, the low voltage-bus may be used primarily for surge power sources. Surge current requirements may be several hundreds to several thousands of amps and a plurality of interleaved bi-boost converters, in some embodiments, 4 to 16 or more may be arrayed to reduce ripple in the drawn current and distribute stresses and heat.

Medium Voltage bus: In some embodiments, the medium-voltage bus may be configured to serve as a bulk-storage bus whose voltage range may be selected to correspond to the voltage range of a second class of storage elements, e.g., a bulk storage battery that may be a series and parallel connection combination of multiple cells or batteries, e.g., a 48V battery.

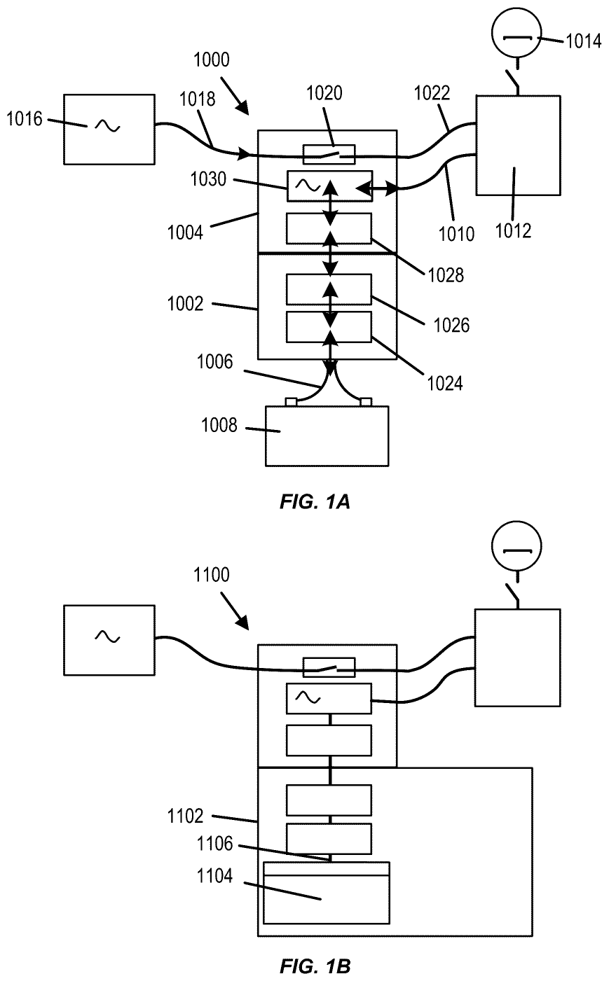

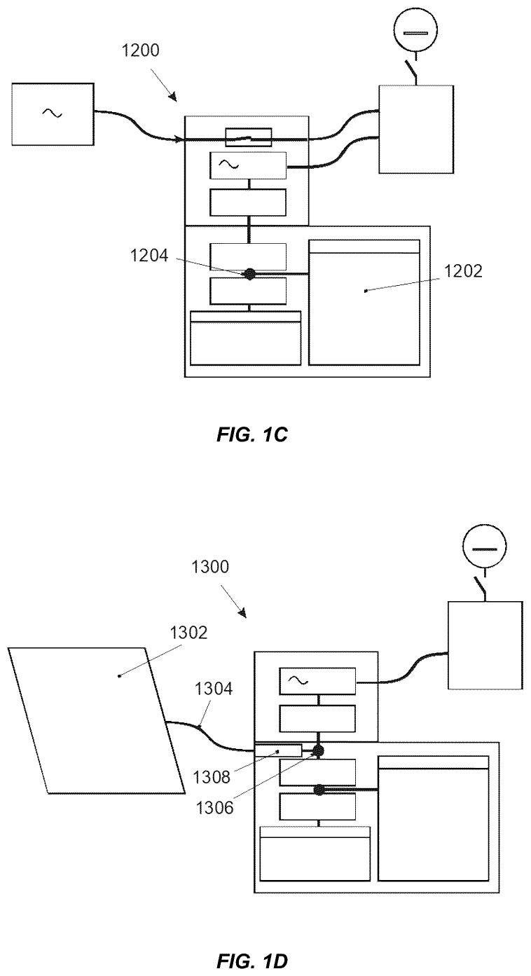

FIG. 1A shows a schematic diagram 1000 of a VSC 1000 comprising a fast bi-boost bank 1002 and fast bi-inverter bank 1004 according to some embodiments. The VSC is connected, e.g., via jumper cables 1006 to an external surge power source 1008 such as a starter battery. The output of the VSC is connected via wires 1010 to an electrical panel 1012 that is disconnected from a power grid connection 1014, e.g., via a master power switch. Element 1016 is a non-islanding PV inverter connected via wires 1018 to an isolator circuit 1020 to wires 1022 to the electrical panel. In some alternative embodiments, elements 1010 and 1022 are the same wires. In some embodiments, the wires 1018 pass into the VSC via a circuit breaker. In some embodiments, the isolator circuit 1020 may be eliminated and the PV inverter connected directly to the electrical panel. In some embodiments, the VSC may be connected to the subpanel via an electrical socket and plug.

Element 1024 is a low-voltage bus to medium voltage bus bi-boost stage. Element 1026 is a medium voltage bus to first voltage bus. Element 1028 is a first-voltage bus to bridge voltage bus that feeds buck inverter stage 1030. In some embodiments, element 1028 and element 1030 may comprise a boost inverter.

Some embodiments of element 1030 may further comprise at least one autotransformer to produce a split-phase AC output. Some embodiments of element 1030 may alternatively produce a split-phase output by individually inverting complementary waveforms. Some alternative embodiments of element 1030 may produce a two substantially 90 degrees out of phase waveforms L1 and L2 having a common connection N. In some embodiments, this may reduce line-frequency ripple current and storage requirements. In such an arrangement, the voltage from L1 to L2 is ˜1.4× the that of L1-N instead of 2×. This arrangement may be satisfactory if there are substantially no induction motor loads from L1 to L2. Such an arrangement may be useful for automatically de-rating heaters and other loads connected across L1 to L2. In some arrangements, the phase between the L1 and L2 circuits may be adjusted or set to a different angle.

The arrows depict the flow of energy through the VSC. This embodiment of a VSC may be useful for emergency response. By making use of the ubiquitous automotive starter battery, the weight and size of transporting each unit may be cut dramatically from a unit having an internal battery or supercapacitor bank. The VSC can keep the battery near full charge. A drawback can be that the battery remains in place for the PV inverter to supply power to the electrical panel.

Modularity of sources: Some preferred embodiments of VSC systems comprise a plurality of modular power sources that may be added to an appropriate bus connector as an option. For example, FIG. 1B shows a schematic diagram of a VSC 1100 whose housing 1102 is modified to hold a super capacitor or ‘starter’ battery 1104 on a low-voltage bus 1106. FIG. 1C shows a schematic diagram 1200 of a bulk-storage battery bank 1202 connected to a medium-voltage bus 1204, turning it into a bulk storage bus. FIG. 1D shows a schematic diagram of a VSC 1300 wherein a solar array 1302 is connected via wires 1304 to the first bus 1306 through circuitry 1308 allowing the VSC to act as a photovoltaic inverter that provides bulk power and battery charging during the day, etc.

In some embodiments, the connection 1304 may be a plurality of wires comprising a connection to the positive-most and negative-most terminals of a PV panel in a series-connected string. Some embodiments of 1304 further comprise at least one wire teed to the connection between two PV panels in a series connected string and preferably one wire teed to all inter-panel connections within a string. Some embodiments further comprise similar connections to one or more other series strings of panels. Circuitry 1308 may comprising one or more of: a switch, diode, or circuitry to control or prevent unwanted back-feeding of current, rapid shut-down circuitry in which each solar panel voltage is held at a low voltage level by substantially short circuiting each pair of wires that connect across the positive and negative terminals of each solar panel, a balancer circuit by which excess current may be drawn from an over-performing solar panel, deficit current may be fed to an under-performing solar panel, or both to power optimize each panel in a string. Some embodiments of balancer circuits may further comprise individual bulk-storage batteries.

Some embodiments further comprise a connection to an electric car main battery. Depending on the battery voltage, this battery may be connected to a bridge bus, first bus, medium-voltage bus, or auxiliary bus. In some embodiments, this battery may provide bidirectional bulk and surge power.

As used herein, a switch is one or more of: a transistor, MOSFET, IGBT, thyristor, SCR, solid-state relay, vacuum tube, mechanical relay, or mechanical switch, each having preferred applications, limitations and operating requirements as known in the art. For example, a MOSFET may be preferred for high-current and lower voltages. An IGBT may be preferred for at higher voltages. An IGBT may need an external diode to behave like a MOSFET in a power circuit. The actual switch symbol used within a schematic circuit diagram is not intended to be limiting. In some instances, a switch may be replaced by a diode and vice versa and an explicit external diode may be eliminated if a switch has an appropriate body diode as known in the art. Schematic diagrams are also simplified for clarity.

Electrical schematics shown in the figures are simplified and not intended to be limiting. Some embodiments of converter circuits further comprise resonant circuits and active circuits for soft switching, snubbing, and the like. Some embodiments may employ synchronous rectification, buck-boost circuitry, and the like.

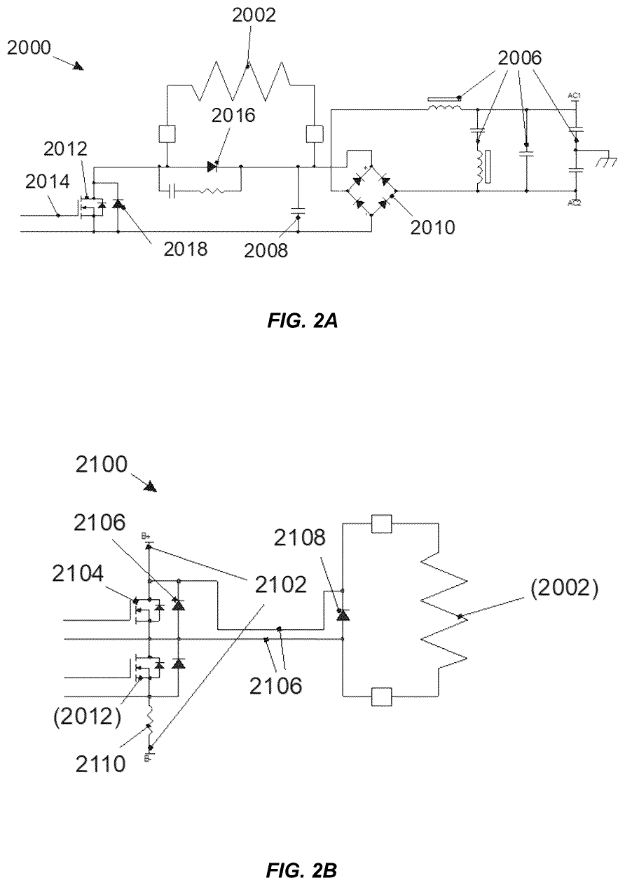

High-speed, high-power dump “snubber”: Some embodiments may employ an agile power dump at various times to snub or shunt an unwanted current or voltage transient, to counter a voltage overshoot that may be produced by residual current in an inductor after reacting aggressively to a power surge, or to establish a reserve capacity that can be quickly supplied by turning off the dump. FIG. 2A shows a schematic diagram 2000 of an embodiment of a fast dump circuit that can apply a high-power substantially resistive load 2002 across AC power 2004, e.g., to counter a voltage or power spike or establish a reserve power when storage is at capacity and there is surplus power. Elements 2006 and 2008 are filter circuitry to isolate switching noise arising from turning on and off or pulse-width modulating (PWMing) the application of load 2002 from the AC power lines. Element 2010 is a full bridge rectifier to allow a simple switch 2012, e.g., a MOSFET or IGBT as known in the art to apply the load via an isolated gate driver signal 2014. Inductance of 2002 may necessitate a diode 2016 to avoid overstressing the switch 2012 on turn off. External diode 2018 may not be needed if switch 2012 has a suitable body diode.

FIG. 2B shows a schematic diagram 2100 of an alternative fast dump circuit that can be applied across a DC bus 2102 by switching 2012. Some embodiments may further comprise an optional upper switch 2104 that parallels or replaces diode 2016. The lines 2106 may depict a lengthy connection to load 2002. In some embodiments, the inductance of and electromagnetic interference (EMI) of 2106 is minimized by running the wires or traces next to each other and possibly twisting them. For a reduction in EMI, diode 2108 may be placed proximal to the load. Element 2110 is an optional current-sensing resistor that may be used to quantify the dumped current.

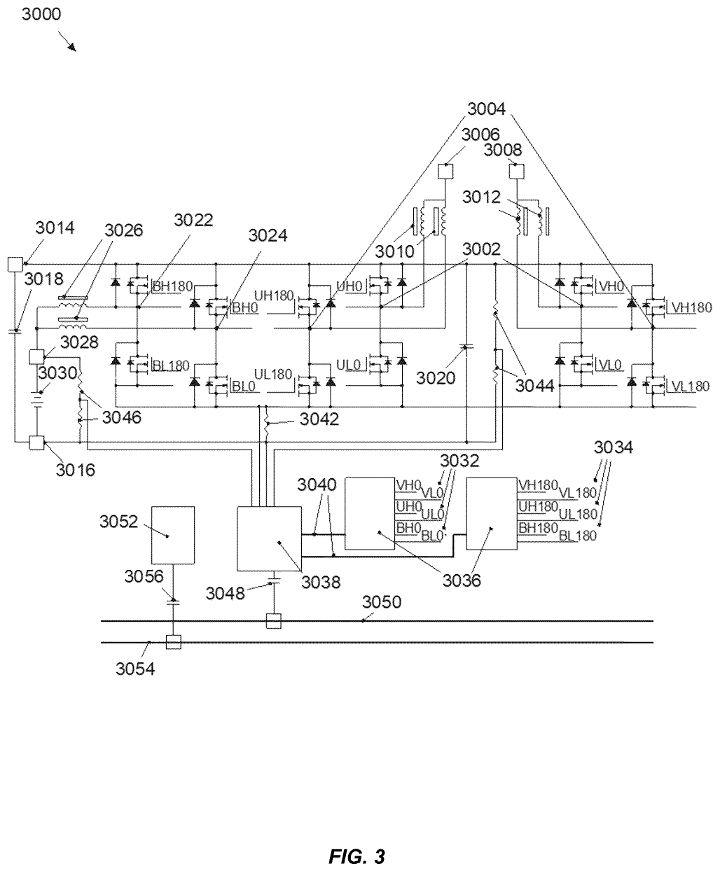

Interleaved inverter bi-boost module: FIG. 3 shows a schematic diagram 3000 of an interleaved inverter bi-boost module (IIBB), comprising one full bridge with switched nodes 3002 phase interleaved by 180° with one full bridge with switched nodes 3004 These switched nodes are combined to terminals 3006 and 3008 through filter inductors 3010 and 3012 respectively that provide AC isolation of the different phases. Some embodiments may mount one or more of these inductors external to the module. Some alternative embodiments comprise 3 or more such inductor-isolated interleaved full bridges switched at substantially evenly spaced phases. Element 3014 is the positive leg of the bridge bus and element 3016 is the negative leg of the bridge bus. Element 3018 is an external and element 3020 an internal capacitor or bank of capacitors across the Bridge Bus.

FIG. 3 also comprises a bi-buck stage comprising a half bridge having switched node 3022 that is interlaced at 180° with a second half bridge having switched node 3024. These switched nodes are combined at terminal 3028 through inductors 3026 which are mounted external to the module in some embodiments. Terminal 3028 connects to the positive side of the first bus (depicted as 3028) which has a negative return that is in common with the negative side of the Bridge bus. Periodically switching the bottom-side switches connected to 3022 and 3024 effects a voltage boost. Switching the upper switches connected to 3022 and 3024 on steadily, forces the bridge bus and first bus to substantially the same voltage and periodically switching the upper switches allows power to flow from the Bridge bus to the first bus, e.g., when the full bridge is sinking power from the AC circuit and this power is cascading down the buses to charge storage elements.

Some embodiments comprise a greater number of interleaved full bridges. Some embodiments comprise a plurality of parallel bridge circuits whose switching is not interleaved. Some alternative embodiments comprise a single copy of a bridge circuit.

Some embodiments of an interleaved converter may be adversely affected by filter inductor saturation especially when operated in the continuous-conduction regime. An individual phase current measurement may be used to derate to derate a phase having a higher current than another phase. This derating may be applied via an analog calculation or a digital calculation.

Some embodiments comprise at least one filter inductor having a shield designed to saturate over a comparatively narrow range of inductor currents, further comprising a sensor inductor in magnetic communication with a leakage field of the saturably shielded filter inductor. An isolated current signal or an over-current indication may be derived by thresholding, amplifying, filtering, bridge rectifying, etc., the signal induced in the sensor inductor. Some embodiments employ such an isolated over-current indication to inhibit a switch.

The gate signals that switch the interleaved full and half bridges, 3032 and 3034, respectively may be produced by a number of individual or ganged high-side/low-side gate driver 3036. In some embodiments at least one high-side gate driver may be bootstrapped as known in the art. In some embodiments at least one high-side gate driver may be powered by an isolated power supply, for example to allow the upper legs of the bi-boost half bridges to conduct continuously. Some embodiments of gate driver circuitry comprise shoot-through protection.

Element 3038 is a microcontroller that controls the gate switching via outputs 3040. In some embodiments, the microcontroller incorporates shoot-through protection. Element 3042 is an optional current sense resistor that may be sensed by a microcontroller or smart power module to detect a fault current. Elements 3044 comprise a resistive voltage divided that may be used by the microcontroller to sense the bridge bus voltage. Elements 3046 is a resistive voltage divider that may be used by the microcontroller to sense the first bus voltage. Element 3048 is an optional voltage isolator that may comprise a capacitor and additional circuitry such as centering diodes or demodulation circuitry, an optocoupler, a radio-frequency (RF) coupler, a photo-sensitive element, etc., in communication with a communications, hand-shaking and control bus 3050. In some embodiments, this control bus is driven by a master microcontroller. In some embodiments, this control bus is common to a plurality of IIBB modules.

Element 3052 is an isolated low-voltage power supply for operation of the module, coupled to an isolated power source bus 3054 via isolator 3056, which may be a capacitive or inductive isolator or RF isolator or isolated DC-DC converter as known in the art.

Inverter: Some embodiments of VSCs comprise at least one DC to AC power converter circuit, called an inverter. Some preferred embodiments of DC to AC power circuit comprise a ‘modular converter’ circuit comprising at least one full-bridge switch circuit to produce a substantially complementary PWM waveform on a first switched node and a second switched node from the second bus voltage as known in the art.

Bi-boost: Some embodiments further comprise at least one half-bridge switch circuit wherein a third switched node is connected through an inductor to the first bus voltage. In some embodiments this half bridge provides a voltage boost capability from the first bus to the second bus via periodically switching the lower switch in the half bridge. In some embodiments, the body diode of the upper switch or an external diode paralleling the upper switch may provide a flow path for boost current. In some embodiments, the upper switch of the half bridge may be switched as a synchronous rectifier to reduce loss cause by current flow through this diode. Some embodiments further comprise switching the upper switch to permit a reverse current flow: from the second bus to the first bus. In some embodiments, this reverse-current flow may discharge excess capacitive energy in the second bus that may be fed by sinking power from an AC power circuit. In some embodiments, this reverse-current flow may feed energy to at least one charging circuit that draws power from the first bus and supplies it to a bidirectional power source.

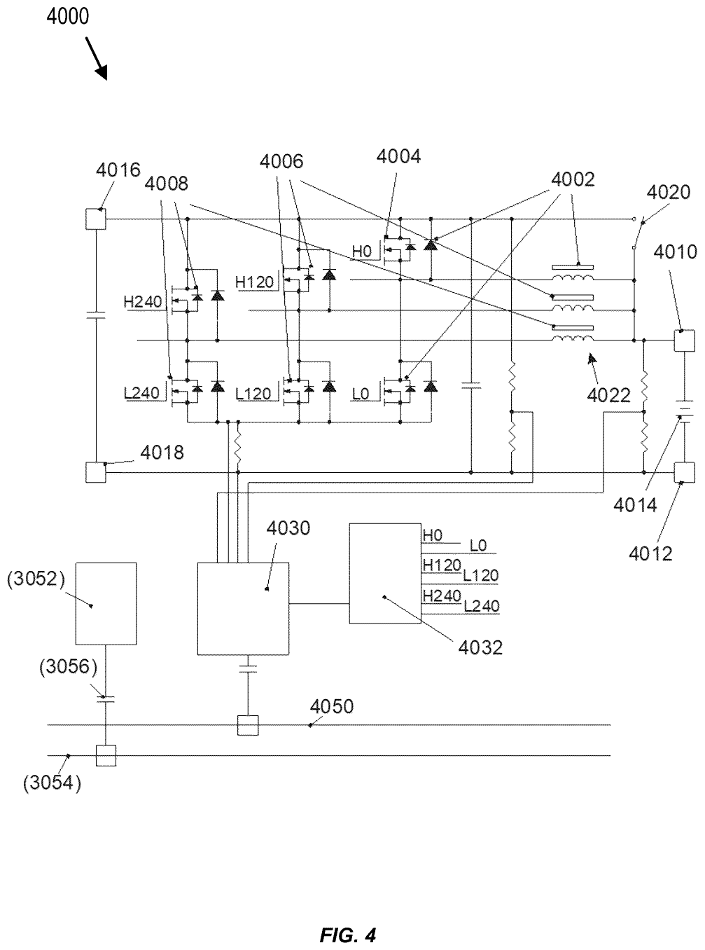

Interleaved Bi-boost module: FIG. 4 shows a schematic diagram 4000 of an embodiment of an interleaved bi-boost stage.

Some embodiments of a bi-boost converter comprise a conventional boost converter circuit 4002 and further comprise at least one switch at the upper leg of a half bridge 4004 in the position of a traditional synchronous rectifier as known in the art. In this bi-boost circuit, the upper-leg switch may be turned on periodically or otherwise to allow a controlled current to flow from the high-voltage node through a filter inductor to the low voltage node to provide for recharging of the first power source. Some embodiments of such switches are designed to provide for high agility surge-power recharging of a first power source (4014) so that the power source can serve as a fast power sink. Some embodiments of boost converters may also close the upper leg of half bridge continuously or quasi-continuously to reduce a diode forward voltage loss when a voltage boost between the input source and output bus is not needed. Some embodiments may further comprise a switch (4020) to bypass a filter inductor when voltage boost is not needed.

Agile current response: In some embodiments, the bi-boost converter is designed to allow a rapid rise in boost current via a reduction in filter inductance. In some embodiments the current ripple produced by this reduction in filter inductance may be partly canceled by the use of a plurality of converter circuits 4006 and 4008 operating with substantially evenly spaced “interleaved” switching phases. An advantage of interleaved operation may be to reduce voltage and current ripple, improve time response, and physically spread heat sources for enhanced cooling.

Element 4010 is a positive-side low-voltage input terminal and element 4012 is a negative-side low-voltage terminal. Power source/sink 4014 is depicted as a battery, but may be alternatively be a capacitor, a supercapacitor, a renewable energy source, a voltage bus, or another power source/sink. Positive output terminal 4016 may connect to another voltage bus or power source/sink. In this embodiment, negative output terminal 4018 is in a common with 4012. In some embodiments, one or more high-side switches, e.g., 4004 may be powered on substantially continuously if no boost is necessary. In some embodiments a switch 4020 may be closed to bypass the filter inductors 4022.

Some embodiments may comprise a bi-boost interleaved module stage wherein the filter inductors 4022 may have an inductance between 1 and 100 μH and preferably between 3 and 30 μH and a saturation current between 50 A and 1000 A and preferably between 80 and 300 A. Some embodiments may further comprise a bi-boost stage wherein the filter inductors may have an inductance between 50 μH and 1000 μH and preferably be 80 and 300 μH and a saturation current between 10 and 200 A and preferably between 20 and 60 A.

In some embodiments, the filter inductors (4022) may comprise transformers. In some embodiments the transformers may comprise center-switched autotransformers having a windings ratio that provides additional voltage boost. In some embodiments a secondary winding may supply power to an isolated voltage bus.

Some embodiments of bi-boost modules further comprise a microcontroller 4030 and gate driver circuitry 4032, (c.f., 3038, 3036) that may interact with sensors and a control bus (4050) as described for FIG. 3. Some embodiments use the same control bus for more than one stage. Some embodiments use the same control bus.

Some embodiments of bi-boost modules may comprise a different number of interleaved phases, e.g., 2 to about 16. Some embodiments of modules may limit the number of individual interleaved phases per module for engineering or cost purposes. In some embodiments, a plurality of bi-boost modules may be arrayed. In some embodiments at least one arrayed bi-boost module switching is phase interleaved from another module's switching. Some embodiments may comprise one or more smart power modules as known in the art.

Power dump/active snubber: Some embodiments of modular converters further comprise a low-side switch and diode or half bridge circuit as shown in FIG. 2B whose switched node is connected to a ‘dump’ power resistor to the first bus. Some such dump resistors comprise a resistive element in the 1 to 100 Ohm range and a surge power capability comparable to the power rating of the other half bridges in the module. Some such dump resistors further comprise an inductance of the order 100 nH to 1 mH and preferably between 1 and 100 μH at a bus voltage of ˜370 V, and scaling with bus voltage. Some dump resistors may comprise a wound high-temperature resistive wire such as a nichrome, iron, steel, etc., wire as known in the art.

Control: Some embodiments of VSCs comprise at least one master controller and at least one modular converter in electrical or isolated electrical communication. A master controller may comprise a microcontroller having the ability to perform real-time control-loop calculations and sensing of a plurality of analog signals including one or more of: partially filtered AC voltage, partially filtered AC current, bridge current, bridge voltage, bus voltage, first bus voltage, low-bus voltage, medium bus voltage, PV array voltage, PV array current, bulk battery voltage, bulk battery current, bulk battery temperature, surge battery voltage, surge battery current, surge battery temperature, supercapacitor voltage supercapacitor current, external PV inverter voltage, external PV inverter current, heat-sink current. A master controller may also comprise the functionality of an ‘agent’ module as disclosed in US 2021/0376613, an AC-side agile isolated power dump module to apply to prevent AC over-voltages, e.g., when bus storage or other storage elements are at capacity or to maintain a reserved capacity. A master controller may also comprise an agile isolator between an external PV inverter and AC power circuit intended to isolate an inverter from voltage excursions from surge loads that could cause the PV inverter to trip to a state where it stops delivering AC power. Some embodiments of a master controller may control a rapid-PV-shutdown capability as disclosed in U.S. Pat. No. 10,833,599. Some embodiments may control the per-PV-panel power optimization via a balancing circuit as disclosed in U.S. Pat. No. 9,136,703. Some embodiments of master controller may further comprise a wired or wireless communication, monitoring, or control channel either directly or through an interface circuit or controller as known in the art.

Some embodiments of modular converters comprise and at least one or more of: three-phase smart power module, microcontroller, communication circuits, handshaking circuits, isolated circuits, isolated power low-power supply, sensing circuits, filtering circuits, digitizing circuits.

Control and feedback bus: In some embodiments, a microcontroller in a modular converter may set or adjust a PWM duty cycle according to the duration, frequency, or other modulation of a received pulse train. In some embodiments a microcontroller may set or adjust at least one PWM duty cycle according to an analog signal demodulated from a signal on an isolated circuit. In some embodiments, a control mode change may be triggered via a digital communication, hand-shaking, or clocked line as known in the art. In some preferred embodiments, the communications, hand-shaking, and control lines are bussed so that a master controller may control the switching of a plurality of modular converters.

Some embodiments of a microcontroller in a modular converter may enforce interleaving phase timing on a plurality of interleaved switches. Some embodiments comprise a pulse train having a frequency that is the individual switching frequency times the number of interleaved circuits, each pulse width individually modulated to provide the proper instantaneous duty cycle based upon a control algorithm, the microcontroller synchronously picking the pulses for its controlled switches from the train according to a cyclic pulse count, then applying a correspondingly scaled version of the duty cycle to the switch so as to apply the same duty cycle to the switch at a divided switch frequency. Some embodiments may comprise an alternative modulation scheme for the cycle-by-cycle switching duty cycle. A microcontroller may read or infer its positions in a pulse count via a number of static or dynamic methods practiced in the art, including a jumper, firmware, non-volatile memory setting or random ordering algorithm.

Some embodiments further comprise a de-rating calculation, in some embodiments based on a temperature measurement, bridge or switched-node current measurement, magnetic-saturation-based measurement, state-of-charge measurement, calibration, or internal control algorithm, whereby the received duty cycle is scaled or otherwise modified before being applied to a load. In some embodiments, this de-rating calculation may improve load balancing between phases.

Some embodiments of modular converters comprise at least one switch-gate signal that is determined via an analog, digital, or hybrid analog and digital calculation in a microcontroller in the module. Some embodiments comprise at least one switch-gate signal that is determined by a comparator. For example, a bi-boost controller may be locally controlled via a microcontroller to maintain a target voltage or voltage range.

VSC configurations: Some embodiments of VSCs that support a non-islanding PV inverter may comprise one or more of: a bi-boost inverter, a low-power inverter, an AC-side power dump stage (e.g., 2000), a fast isolator circuit, in electrical communication with the non-islanding PV inverter. Some such embodiments feed the non-islanding inverter an AC waveform while isolating the inverter from an electrical panel power circuit. Some embodiments activate a power-dump stage to maintain a voltage waveform after the inverter begins to produce power, some embodiments close a fast isolator to connect the non-islanding inverter to loads.

Some such embodiments further comprise one or more of: interleaved inverter bi-boost module, interleaved bi-boost stage, surge power source, bulk-power source, DC renewable energy power source, a switchable connection to a power load.

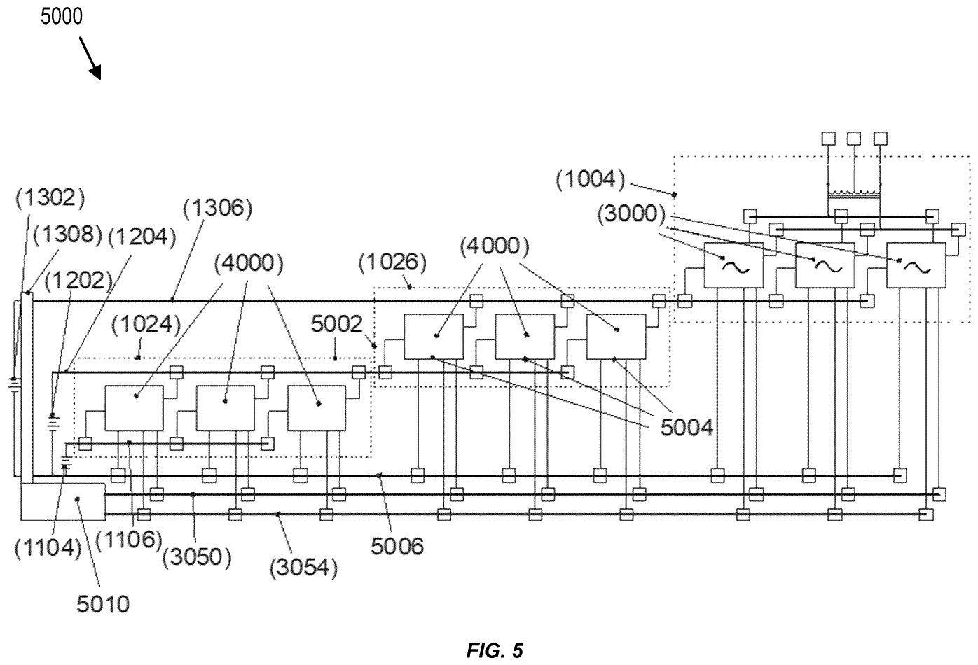

Inter-module interleaving, arraying, and cascading: FIG. 5 shows a schematic diagram 5000 of VSC capable of further comprising a standalone PV inverter, comprising a cascaded (5002) and arrayed (5004) arrangement of interleaved bi-boost modules (4000). FIG. 5 further shows an arrayed arrangement of interleaved inverter bi-boost modules (3000). Element 5006 is a common negative power voltage bus. Element 5010 is a master control module. In some embodiments element 1308 comprises electronics to control power flow to and from a renewable energy source, balancer-based power optimizer, rapid shut-down device, etc. In some embodiments, 1308 employs control bus 3050 and power bus 3054. In some embodiments, 1308 may be integrated with 5010.

Control system: Some embodiments of VSCs comprise a master controller that repeatedly performs at least one sensing operation and at least one calculation to determine an instantaneous switch duty cycle and period and further transmits a demodulatable analog of this duty cycle and period on an isolated control bus.

Some embodiments of master controllers further comprise circuitry to sense a partly filtered AC current, such as a hall-effect sensor, current transformer, current-sensing resistor as known in the art, and AC voltage measurement such as a resistive voltage divider as known in the art.

Some embodiments of VSCs further comprise at least one circuit that may demodulate the duty-cycle and period. Some embodiments of VSCs further comprise a microcontroller or digital or analog circuitry in communication with the demodulator output that may modify or compensate the duty cycle according to at least one measurement.

Ideal waveform model: In order to stabilize a voltage waveform, it may be useful to calculate the instantaneous expected voltage in real time.

In some embodiments it may be useful to produce an analog signal of the expected voltage or a voltage signal having digital pre-emphasis. Some embodiments comprise a digital to analog converter. Some embodiments comprise at least one analog computation stage. Some embodiments produce the difference waveform between the expected voltage and a signal comprising a scaled version of the voltage waveform. Some embodiments further comprise filters including low-pass, band-pass, and notch, and high-pass filters, as known in the art. Some embodiments may further comprise one or more of: addition, subtraction, logarithm, multiplication, absolute value, derivative, integrator analog filter. An objective of such analog calculations, in some embodiments, may be to produce a signal to apply to a comparator or other feedback circuit. An advantage of such a technique may be to reduce the latency in responding to a fault or otherwise to increase the frequency response of a control loop.

Some embodiments comprise a fast analog to digital converter and digital signal processor to reduce control latency.

The decomposition of a waveform into phase, frequency, and rms voltage is arbitrary and over-defined if these parameters are allowed to be time varying, but this decomposition nevertheless may be useful, since in an ideal waveform, only the phase varies in time and the variation is linear. An ideal grid voltage may typically be a sine wave, but an actual grid or powerline voltage is often somewhat distorted from this ideal, but substantially periodic. As used herein, “base waveform” refers to the substantially periodic part of the waveform. The frequency may be defined as the derivative of the phase.

As used herein, an “analog signal” or simply “signal” refers to an analog of a real waveform, e.g., a resistively divided, level-shifted, and low-pass filtered analog of a current or high voltage applied to low-voltage circuitry, such as op-amps, comparators, analog to digital converters, etc. or produced by a digital to analog converter, etc. A “signal” may also refer to a digitized analog signal or a plurality of digital numbers.

A computationally expedient means of calculating an instantaneous voltage waveform may be to approximate a normalized base waveform by a discrete lookup table indexed by phase. In some embodiments the instantaneous model voltage is calculated by scaling by an average-voltage parameter the indexed entry of this base waveform or an interpolated combination of indexed entries. In some embodiments at even time intervals, the modeled synchronous phase is obtained by adding a phase interval that is substantially constant over a quarter, half, or full wave cycle. A frequency or cycle period may be calculated from the phase interval or vice versa. In some embodiments, a lookup table may contain phase-interval entries for a fixed voltage interval or another parameterization scheme as known in the art.

In some embodiments a comparison between the computed waveform model and AC waveform signal may be performed by digital or analog means to quantify an error signal.

In some embodiments, the discrete lookup table values may be updated over time to reduce a systematic, periodic error in the model vs a voltage signal. This may be useful to avoid excessive power dissipation when a virtual synchronous condenser is applied to a high-power microgrid, e.g., if a generator is producing the base power waveform. In such embodiments, the frequency and phase in the model may be updated periodically to maintain synchronization with such a source. In some circumstances, a virtual synchronous condenser embodiment may be used to improve the stability or frequency of one or more generator by forcing a fixed operating frequency or limiting the range of phase or frequency adjustments it tolerates.

In some embodiments, a lookup table may be saved to non-volatile memory. In some embodiments, a lookup table may be constructed or amended via computations.

In some configurations, a technique used may be to quantify the instantaneous difference between an expected voltage and measured voltage and assign portions of the error to one or more of synchronous voltage, phase, and frequency. Some such assignments may be weighted according to the instantaneous derivatives of voltage with phase. For example, it may be advantageous to vary the synchronous voltage with frequency or to allow the synchronous voltage to rise or fall independent of frequency to reduce heating in connected induction motors, to signal to a PV inverter to throttle back power production, etc.

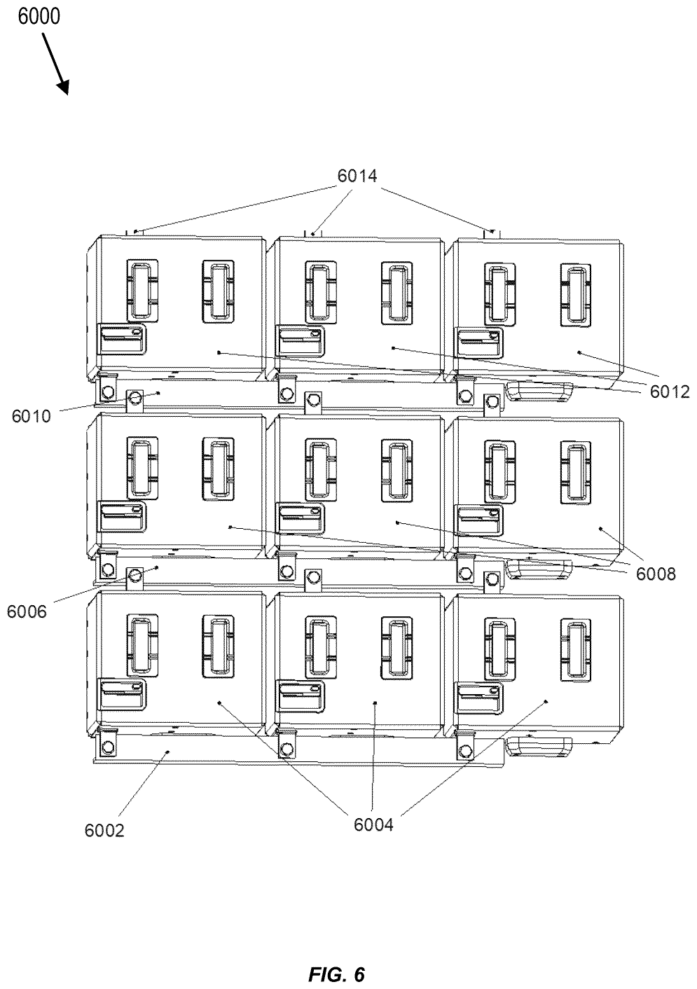

FIG. 6 is a drawing of an embodiment 6000 of a VSC system comprising paralleled and cascaded power modules. While this embodiment shows three paralleled modules, this is not intended to be limiting: embodiments may parallel a number of modules or comprise a single module. Element 6002 is a low-voltage bus (1106) bar. In the embodiment shown, this bar connects in parallel to the input of low-voltage stage bidirectional boost modules 6004. Some embodiments may avoid paralleling at least one input. In some embodiments, this may provide support for multiple, non-paralleled batteries, different battery types or battery ages, improved management of battery state or charge, etc., as known in the art. In the embodiment shown, the outputs of modules 6004 are paralleled at a medium voltage bus (1204) bar 6006. Such an embodiment may further comprise a common battery 1202. Some alternative embodiments may avoid paralleling at least one output and may connect to a plurality of un-paralleled batteries for the same reason. Some embodiments may not comprise a battery 1202. In some preferred embodiments, the decision to parallel one or more modules may be made by an installer, e.g., by selectively installing jumpers, etc.

Some embodiments comprise methods of operating 6004 such that at least one battery 1202 experiences lower or clipped power surges, a reduction in or clipped slew-rate of battery current, a controlled state of charge, a controlled temperature. This may protect battery 1202 from damage or loss of capacity.

Elements 6008 comprise higher-voltage boost modules, cascaded on the outputs of 6004. The output of these modules may be paralleled via high-voltage bus bar 6010 or one or more may be kept unparalleled as described above. Some embodiments may further comprise one or more high-voltage batteries in electrical communication with bus bar 6010. Some embodiments may further comprise one or more strings of photovoltaic modules or other power sources or sinks in electrical communication in parallel or separately to the output of at least one module.

Some embodiments comprise methods of operating such that 1302 experiences lower or clipped power surges, a reduction in or clipped slew-rate of battery current, a controlled state of charge, a controlled temperature.

Some embodiments further comprise one or more additional cascaded voltage boost stages as known in the art. Such embodiments may comprise a plurality of power sources that entail different voltage settings or ranges.

Embodiment 6000 shows three inverter (3000) modules 6012 in electrical communication with the output of one or more boost modules 6008. The outputs of these inverters 6014 in some embodiments may be paralleled. In some embodiments, the outputs of these inverters may be kept separate. In some such embodiments, the output of at least one inverter may comprise a waveform having a phase shift relative to another inverter. In some preferred embodiments, the phase shift may be a multiple of 120 degrees. In some embodiments the phase shift may be a multiple of 90 degrees. An advantage of this arrangement may be to reduce cyclical power variations. An advantage may be to allow the inverters to drive a multiple-phase system.

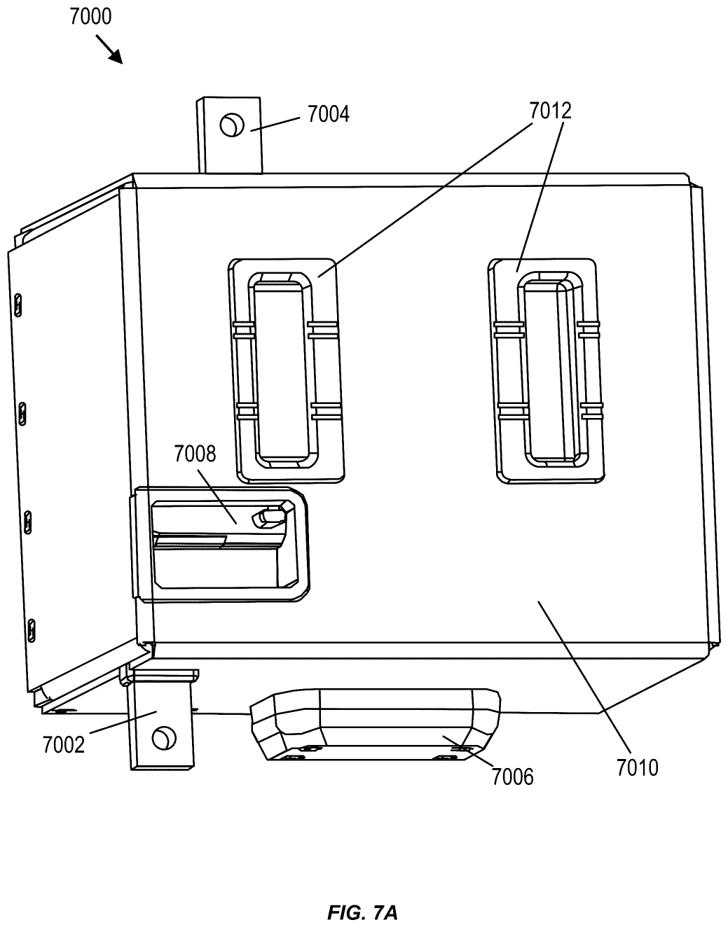

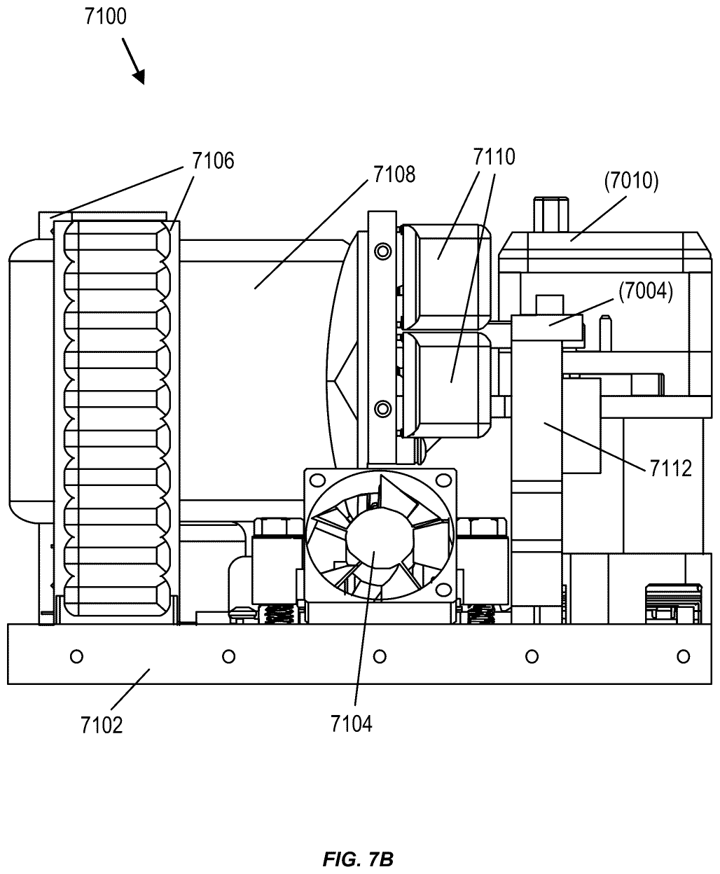

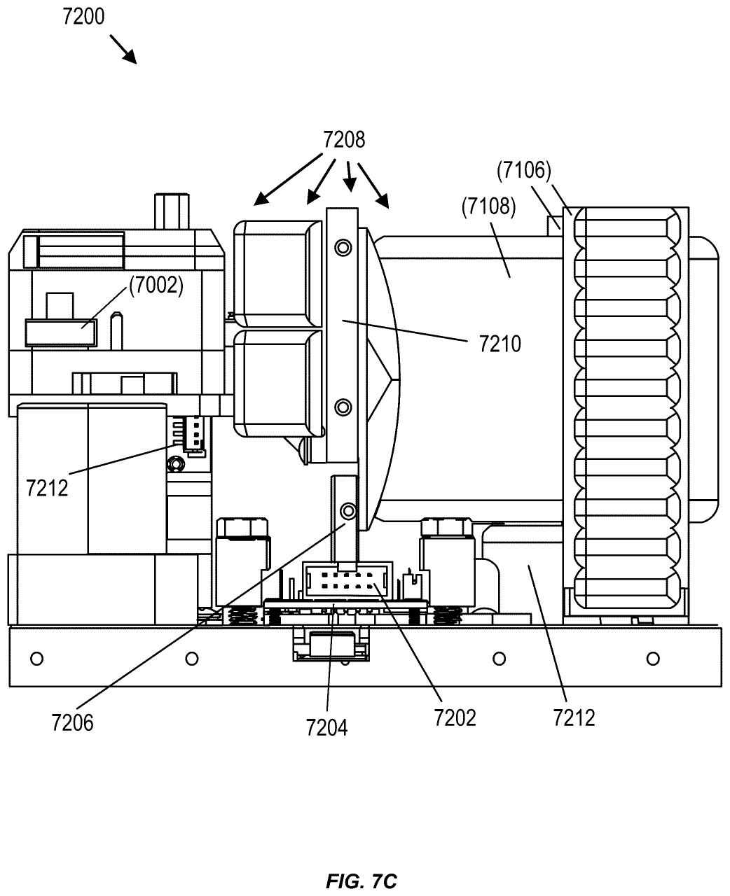

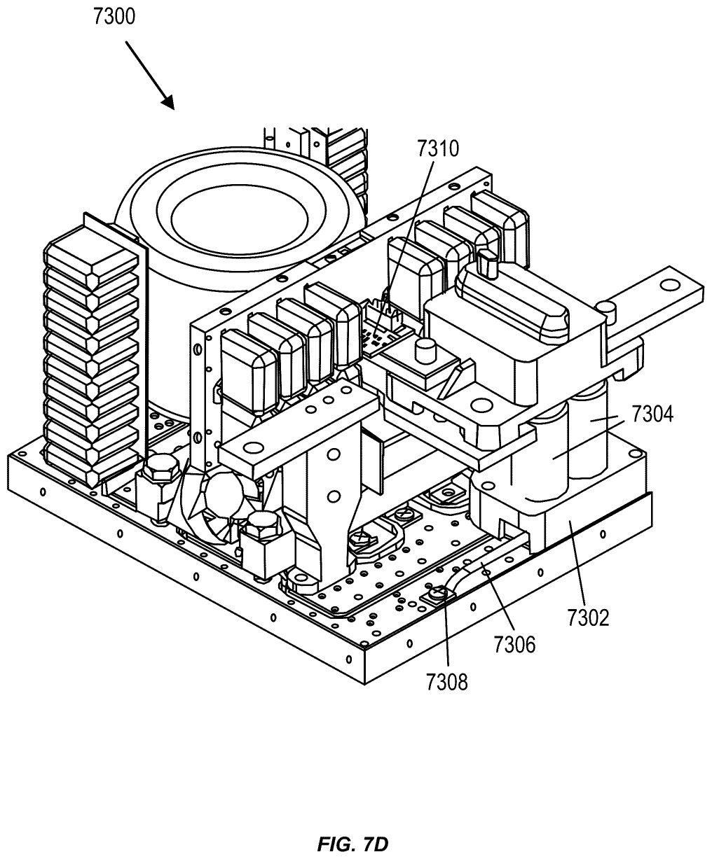

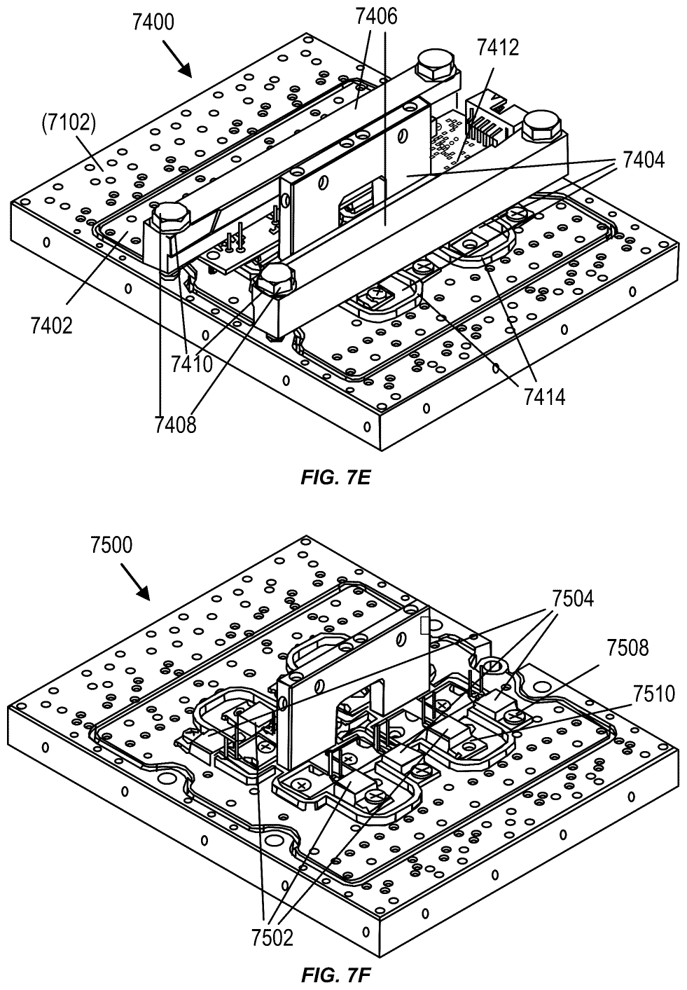

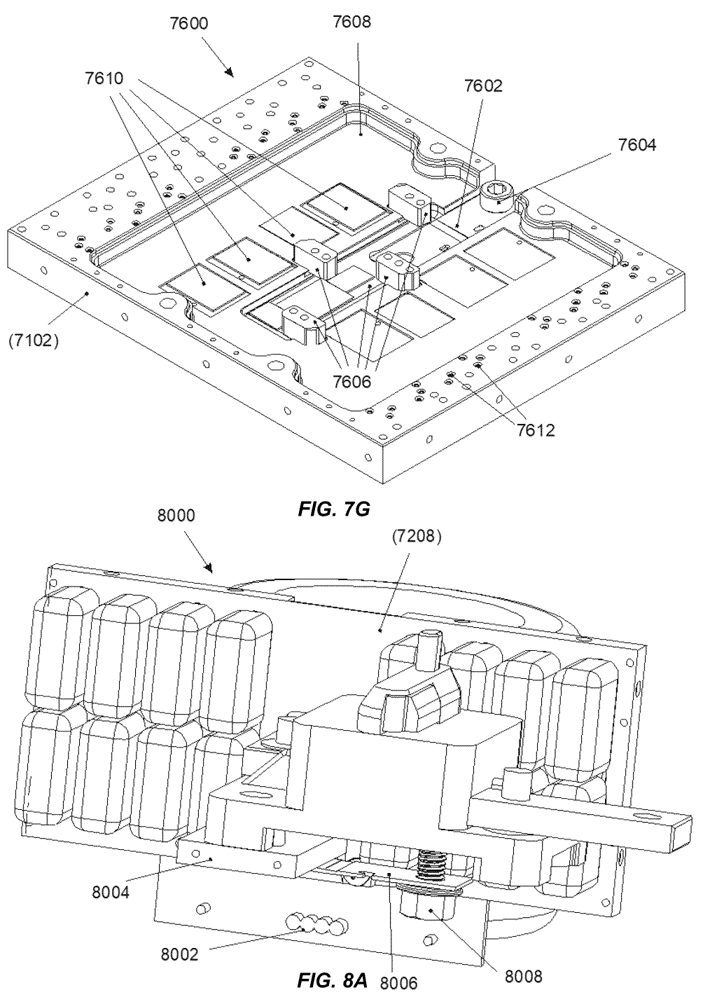

FIG. 7A shows an embodiment 7000 of a bidirectional boost power module, e.g., one of 6004 or 6008 in assembly 6000. Element 7002 is a lower-voltage terminal. Element 7004 is a higher-voltage terminal. Element 7006 is a controller and control interface. Some embodiments comprise a circuit-breaker or protective element 7010 that may further comprise one or more indicators. Element 7010 is a chassis. In some embodiments 7010 is a conductive chassis in electrical communication with a common ground circuit. In some alternative embodiments 7010 is in electrical communication with earth ground. In some embodiments 7010 comprises a weakly conductive material or an insulator. In some embodiments, 7010 comprises a laminate of a conductive material and an insulator. Elements 7012 comprise hand grips to facilitate insertion and removal of a module. In some embodiments, 7012 may articulate to activate or release a clamping mechanism that does one or more of: secures the module mechanically, makes at least one electrical connection, establishes a thermally conductive connection, turns on or off the operation of the module, sequences electrical power, safely hot-swaps the module.

In some embodiments, the chassis may comprise cooling fins. In some embodiments, the back side of the module may comprise a thermal interface to external thermal management.

FIG. 7B shows a top view 7100 of 7000 with chassis 7010 removed. Element 7102 is a common voltage or “ground” plate that further acts as a heat sink, heat spreader, and mechanically strong base. In some preferred embodiments 7102 may be made of a good thermal conductor, such as an alloy of aluminum. Element 7104 is an optional stirring fan that may act to equilibrate the surface temperature of heat producing elements with 7010 and 7102. Element 7106 is an output-side filter capacitor array. Element 7108 is a toroidal filter inductor. Elements 7110 are input side filter capacitors. Element 7112 comprise a riser bar that connects the higher-voltage terminal to the boost circuit.

FIG. 7C shows a bottom view 7200 of 7000 with chassis 7010 removed. Element 7202 is a switch control electrical connector mounted on the switch circuit board 7204. Element 7206 is a conductive riser and mounting block for the inductor 7108. This conductor is in electrical communication with the switched node of the boost converter.

Element 7208 is an input-filter assembly comprising the input circuit protector, filter capacitors, toroid and grounded housing 7210. In this embodiment, loosening four set screws in 7206 releases this complete assembly for removal and easy servicing of the switches.

Element 7210 is an inductor support and thermal interface. Element 7212 is an optional output high-side Hall-effect current sensor and voltage sensor board.

FIG. 7D shows a three-dimensional view 7300 of 7000 with chassis 7010 removed. Assembly 7302 is a capacitor module comprising electrolytic capacitors 7304, nichrome strip 7306, and “grounding” mount 7308. In some embodiments the location of mount 7308 can be adjusted to change the series resistance of the capacitor array. This may assist with tuning a feedback compensation network. This resistance may help to protect electrolytic capacitors from overheating with repetitive high-load fluctuations.

Element 7310 is an optional input high-side Hall-effect current sensor and voltage sensor board.

FIG. 7E shows the view 7300 with the input filter 7208 and capacitor modules 7106 and 7302 removed. Element 7402 is a conductive plate in electrical communication with the filtered boost converter output. Elements 7402 are conductive plates in electrical communication with the switched node. Both plates are maintained in excellent thermal communication with the “ground plate” 7102 and semiconductor switches.

Elements 7406 are high-heat capacity bars that apply a mechanical preload between the switches and their respective plates. This helps to ensure maximal heat transfer from the switches regardless of the switch packaging and electrical pads. In some embodiments, bolts, e.g., 7408 and elastic elements, e.g., Bellville washers, e.g., 7410 maintain a desired preload despite flexure and thermal expansion.

The switch circuit board comprises a high-current gate driver 7412 and snubber circuitry on the reverse side that is in good thermal communication with the ground plate. Insulators, e.g., 7414, ensure a high-voltage holdoff, e.g., >2.5 kV between plates, despite the low inductance and small gaps between them.

FIG. 7F shows the view 7400 with the preload bar mechanism and switch printed circuit board 7204 removed (7500), revealing the arrayed low-side switches 7502 and high-side switches 7504. These switches are arrayed in an interleaved manner. In some alternative embodiments, these switches could be arrayed differently. The manner of arraying may affect inductance, ground bounce, electromagnetic emissions, and heat transfer, etc. In some embodiments, the electrical and thermal connections to the plate may be made via mechanical fasteners, e.g., 7508. In some embodiments, it may be advantageous to maintain electrical and thermal continuity by mechanical pressure on the switch face, obviating a fastener e.g., 7510.

FIG. 7G shows a view 7500 with the switches, switched node plate and switched node plate insulator removed (7600). In this embodiment, a low-side current sense resistor 7602 is used. It is tied to the ground plane by a mechanical fastener, crimp, or preload at 7604. The other side may be soldered to a current-sense voltage bus bar assembly 7606 embedded in a recess in the ground plate. In embodiments that use high-side current sensing or hall-effect input current sensing, resistor 7602 can be eliminated and the bus bar assembly 7606 may be simply merged with the ground plate. Element 7608 is a thin conformal insulator. Elements 7610 are thin, high-thermal conductivity insulators, such as alumina or aluminum nitride plates that lie below the plates that are connected to the switches.

Elements 7612 are alternatives for mounting through-hole components such as Varistors and capacitors or probes. In some embodiments a hole may contain a press-fit pin or conductive spring to facilitate a breakable connection. Similar breakable connections are on the boost output plate and in the input filter assembly. Non-breakable connections to electrical components may comprise a crimp, swage, flow of material, wedge, soldering, spot welding and the like.

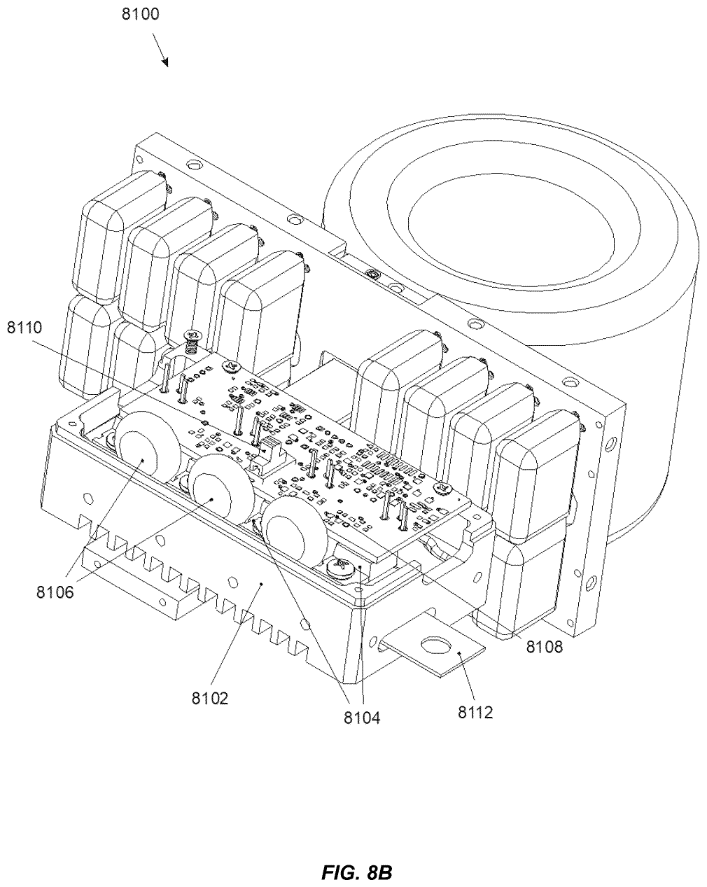

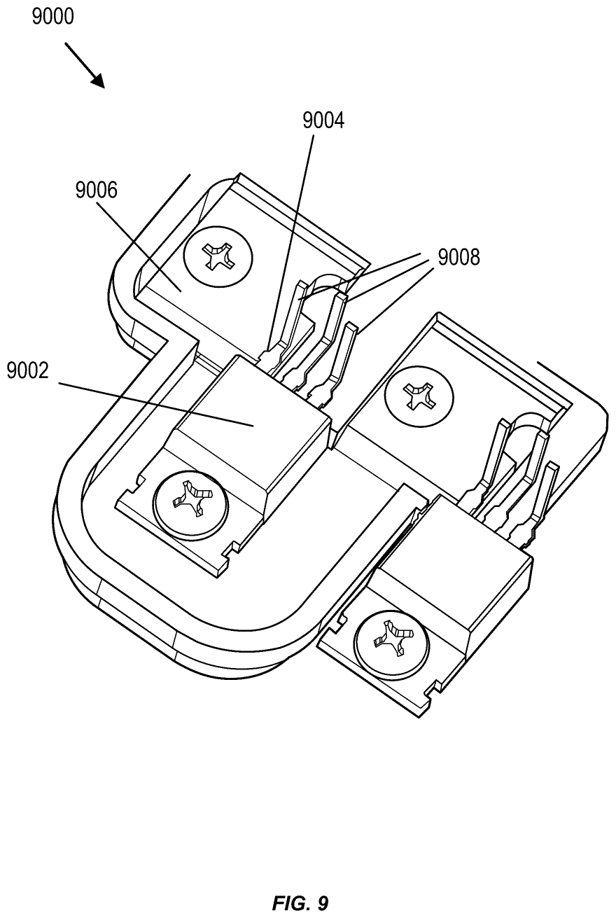

FIG. 8A shows a view 8000 of an embodiment of the input-side filter assembly. The conductors 8002 are clamped in a pocket in the switched-node riser 7206 using set screws. This embodiment shows a ground riser 8004 coming from the input filter housing and bolting to an alternatively arranged low-side current-sensing resistor 8006. The common return line is connected to a bus bar (not shown) by fastener 8008. An issue with this arrangement may be that the ground plates of different modules may not be electrically connected together without creating ambiguity in the path of the sensed current.

FIG. 8B shows a view 8100 of another embodiment of the input-side filter assembly comprising an active breaker assembly 8102. The active circuit breaker uses electronic switches 8104 to interrupt the high-side input current during an over-current event. The active circuit breaker may also comprise over-voltage protection circuitry, e.g., metal oxide varistors 8106. It may further comprise status indicators 8108 and a reset switch 8110. Element 8112 is a high-side current sensing resistor. Some alternative active breakers may employ a Hall effect current sensor. Some embodiments provide a ground or low-side referenced analog current signal as an output. Some embodiments further provide a ground- or low-side referenced analog voltage-sense signal as an output.

FIG. 9 shows a simplified view 9000 of a half-bridge according to an embodiment. A standard switch 9002 is soldered at 9004 to a heat-spreader block 9006 that provides a mechanical fastener or compression interface to a back conductor. In this methodology, a power-bearing pin that does not have provision for a mechanical mount can be converted to a mountable and field removable switch. The soldering assembly process can be manual or fully automated with low stress to the switch by pre-heating 9006. This arrangement allows failed switches to be replaced with simple tools and low stress to other components, even if those switches must carry hundreds of Amps. The heat-spreader blocks further provide thermal mass to resist overheating during a short-duration surge. In this embodiment, the bent legs 9008 of the switch may be soldered or inserted into a socket on a conventional printed circuit board, which can carry gate currents and snubbing currents with modest copper thickness and cost.

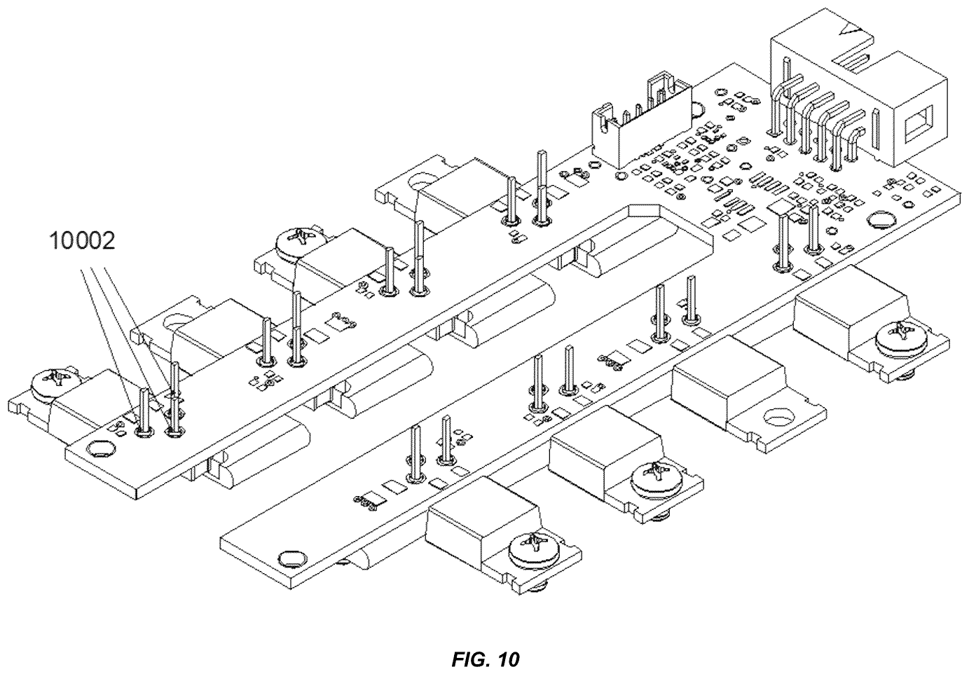

FIG. 10 shows a view of the switches and gate-driving/fault-sensing printed circuit board. In some embodiments, the bent leads of the switches are connected to the printed circuit board using conventional pin receptables (10002). This is possible because the printed circuit board does not carry the bulk current in the power circuit. This allows the printed circuit board to be separated easily from the switches during servicing. In some embodiments, the bent pins have staggered heights to facilitate insertion and, in some embodiments, minimize the risk of electrostatic discharge damage. In some other embodiments, the board and switches may be soldered together, since the failure of one switch may indicate overstress of other switches in the system and failure of one switch may destroy a board-mounted gate driver, necessitating a repair that is difficult in the field. In such an embodiment, the complete replacement of the power switches involves a compact board changeout with simple tools.

An embodiment comprises a method to convert a switch having at least one solderable switched electrical connection into a switch assembly having at least one breakable, mechanical-compression-based electrical connection, such as that shown in FIG. 10. In some embodiments, the method may comprise bending a terminal of a switch device to a position where it can be inserted into a receptacle or plated hole in a printed circuit board.

In some embodiments, this method further comprises producing a lasting electrical joint between a solderable terminal and a conductive interface piece, e.g., 9006. In some embodiments, this joint is formed by one or more of: soldering, spot-welding, welding, induction welding, laser welding, ultrasonic welding, swaging, crimping, epoxying, liquid metal, conductive epoxy, or other technique known in the art for producing a lasting electrical joint. In some embodiments, the interface piece is preheated to reduce the thermal stress on the switch during the formation of a solder joint or weld.

In some embodiments the mechanical compression may be produced by a mechanical preload from a semi-rigid beam or spring, screw, bolt, rivet, swage, clip, thermal pad, etc.

In some embodiments, an electrical contact may be coated by an anti-corrosion grease. In some embodiments, an electrical contact may be coated by a liquid metal.

In some embodiments the mechanical compression may be released to allow removal and replacement of the switch assembly without substantial application of heat.

In some embodiments at least one terminal of the switch assembly may contain an electrical connection to a printed circuit board. Some embodiments of such connections may be made via a spring-loaded contact. Some alternative embodiments of such connections may be made via a solder connection.

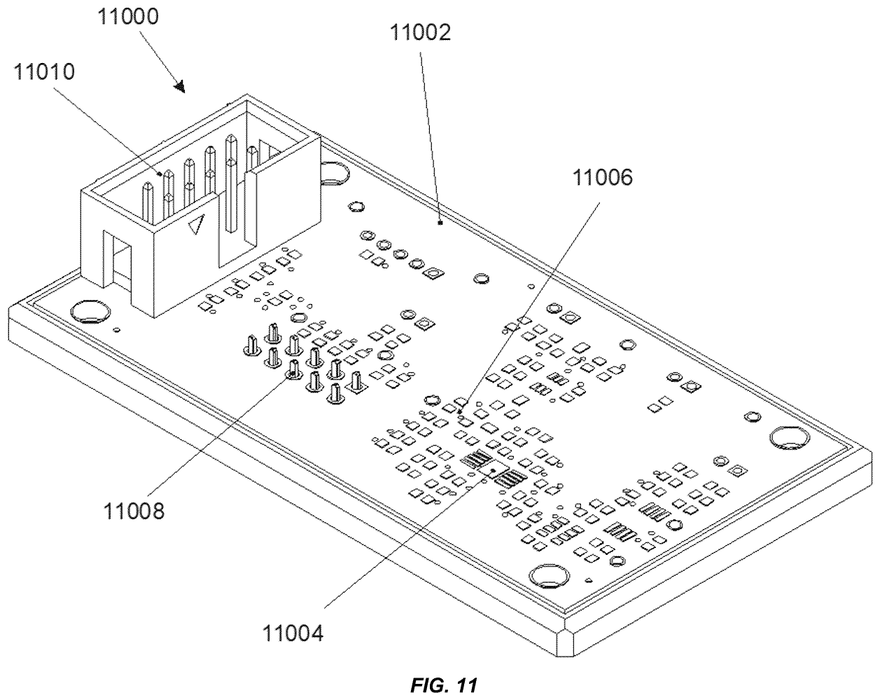

FIG. 11 shows a view 11000 of a switch controller printed circuit board 11002. Such a board may comprise an ASIC or off-the-shelf switching controller 11004 and standard compensation network 11006 to generate a high-performance switch pulse train to send via 11008 to the switch board connector 7202. Element 11010 is a connector to a source of auxiliary power connecter, for example another circuit board or ribbon cable to a power source. The nature and features of the controller may be easily and inexpensively tailored to an application, customized, or parameterized to generate families of high-performance modules. Some customizations may include one or more of: adjustable current limit, adjustable voltage limit, voltage control, current control, slew-rate control, voltage range, switch frequency, spectrum spreading, hiccup-mode retries, fault handling options, soft-start options, control-lines, indicator lines, analog or digital sensing outputs, analog programmability, digital programmability, battery charge control, AC voltage production, AC current production, variable frequency drive output, waveform generation, voltage amplification, current amplification, etc. An advantage of the use of a controller board, in some embodiments, may be the ability to have a power module fully certified and failsafe, allowing the development of smart control algorithms without concern for switch faults during development or debugging.

What is claimed is:

1. A Virtual Synchronous Condenser System comprising a surge power source/sink connected to a low-voltage bus, a bi-boost converter connected between the low-voltage bus and a medium-voltage bus, a bi-boost converter connected between the medium-voltage bus and a first bus, a bi-boost converter connected between a first bus and a bridge bus, a buck inverter connected across the bridge bus that produces an AC power waveform on a power circuit, and a fast-dump circuit connected across that power circuit.

2. The apparatus of claim one wherein the surge power source/sink is a battery.

3. The apparatus of claim one wherein the surge power source/sink is a supercapacitor bank.

4. The apparatus of claim one wherein a bulk storage battery is connected to the medium-voltage bus.

5. The apparatus of claim one wherein a renewable energy resource is connected to the first bus.

6. The apparatus of claim one wherein the power source/sink is an external automotive starter battery.

7. The apparatus of claim one wherein a bi-boost stage comprises a plurality of inductor-isolated half-bridge circuits that change a switch state at substantially even intervals of a switching period.

8. The apparatus of claim one wherein an inverter stage comprises a plurality of inductor-isolated half-bridge circuits that change a switch state at substantially at even intervals of a switching period.

9. The apparatus of claim 7 wherein a bi-boost stage comprises a plurality of bi-boost modules which each comprise a plurality of half-bridge circuits that change a switch state at substantially even intervals of a switching period, wherein a switch state of each bi-boost module's changes at a relative time from each other module state substantially at a sub-division of the even interval by the number of bi-boost modules.

10. The apparatus of claim one further comprising a plurality of PV-panel rapid-shutdown circuits that interface to PV panels within an array.

11. The apparatus of claim one further comprising a balancer-based power optimizer circuits that interface to PV panels within an array.

12. An isolated over-current indicator apparatus comprising a first magnetically shielded inductor and a second sensor inductor in magnetic communication with the first inductor's leakage field, the shield geometry and material designed to saturate at a field substantially near the desired current limit of the first inductor.

13. The apparatus of claim 12 wherein the sensor inductor comprises a magnetic shield that substantially envelops the leakage field from the first inductor but that substantially isolates the sensor inductor from external magnetic fields.

14. That apparatus of claim 12 wherein the sensor inductor comprises an electrostatic shield.
